(19) United States
(12) Patent Application Publication
(10) Pub. No.: US 2002/0194168 A1
(43) Pub. Date: Dec. 19, 2002

(54) System and method for managing metadata and data search method using metadata

(76) Inventors: Jinghua Min, Beijing (CN); Nobutoshi Sagawa, Koganei (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/152,069

(22) Filed: May 22, 2002

(30) Foreign Application Priority Data
May 23, 2001 (JP) 2001-153348

(51) Int. Cl. G06F 17/30

(52) U.S. Cl. 707/3

(57) ABSTRACT

Information management system on the WWW for improving the compatibility of metadata on the WWW, locally managing metadata, which is dispersed, in a manner facilitating search, and thus improving efficiency and precision in search. Domain administration servers are included for acquiring metadata, which is dispersedly saved in servers interconnected over a computer network, from associated managing domains. Each domain administration server includes a metadata management database in which acquired data is recorded, and a search engine that searches the database. The search engine searches the database in response to a query that specifies as known data an identifier, that is, a URI of a resource and an attribute name of the resource, and returns an attribute value as the result of search.

### BACKGROUND OF THE INVENTION

1. Field of the Invention

The present invention relates to an information management system on the World Wide Web (WWW or Web). More particularly, the present invention is concerned with a method of constructing an information management system that permits high-precision high-speed search of target information from among information scattered over the Web.

2. Description of the Related Art

(1) Data Representation Technology

Currently, almost all information (Web pages) disclosed on the Web is written in Hypertext Markup Language (HTML). The HTML enables designers to describe relationships among data items to be referenced (hot links) and a display format but does not enable them to express a data structure and meanings.

Extensible Markup Language (XML) is a sophisticated version of HTML and provides a new Web technology. XML is detailed in “Extensible Markup Language (XML) 1.0—W3C Recommendation” (Feb. 10, 1998). XML enables designers to construct and describe data as a structure and provide each data to be described with a meaning.

Resource Description Framework (RDF) defines a method of describing an attributes of a resource (metadata) (refer to “Resource Description Framework (RDF) Model and Syntax Specification, W3C Recommendation (Feb. 22, 1999),” and “Resource Description Framework (RDF) Schema Specification 1.0, W3C Candidate Recommendation (Mar. 27, 2000)).” An RDF data model is composed of three divisions, that is, a resource division, an attribute division, and a value division, and is a simple and flexible data model. Herein, the resource is a resource that can be designated with an identifier stipulated in the international standard of Universal Resource Identifier (URI), and that is described according to RDF. URI is used to describe an identifier to be assigned to a resource. Whether a resource itself resides on the Web does not count. For example, a uniform resource locator (URL) assigned to a Web page or an ISBN assigned to a book is one kind of URI, and the Web page or book is regarded as a resource. The attribute is an attribute of a resource and described with a name defined as an RDF schema. For example, the creator of a Web page or the title of a book is regarded as an attribute. The value is an attribute value. For example, the title of a book has an attribute value of “XML A Primer.”

When the data description technology of XML and the metadata description technology of RDF are used in combination, data on the Web will have a structure and a meaning. This enables construction of a semantic Web. The semantic Web can be recognized by machines, while the existing Web can be recognized by human beings. Consequently, better Web services can be provided easily.

The World Wide Web Consortium (W3C) actively recommends XML and RDF as international standards.

2. Data Search Technology

Web information search services have rapidly become popular these days. The information search services are classified into three groups of a robot-based service, a directory-based service, and a meta-level service in terms of mechanism.

The robot-based search service provides a Web search engine as well as a Web robot or a spider. Specifically, information present in all WWW servers that can be found on the Internet is automatically acquired periodically, preserved in the form of an enormous database (WWW cache), and indexed. Typical search engines include Alta Vista, HotBot, Lycos, and Infoseek. These search engines prompt a user to enter a keyword relevant to information the user wants to search for, and finds out Web pages requested (keyword search).

The directory-based search service provides a World Wide Web directory and is represented by Yahoo!. A directory editor classifies new Web pages by hand into proper categories. A user follows a category tree (directory) to search for a relevant item (directory search or category search).

The meta-level search service is rendered using a search system that does not own a database. Specifically, a search request issued from a user is transferred to a plurality of search systems for rendering the robot-based search service and directory-based search service. The result of search is manipulated and edited, and then returned to the user.

Currently, metadata is described and managed in a manner specific to each search system. Moreover, a description format is not standardized among the search systems, and the compatibility of metadata with other search systems is low. It is therefore hard for the search systems to share the same metadata. Moreover, the amount of metadata scattered on the Web and not managed has rapidly increased with the fast growth of the Web. It has become a critical issue how the metadata is managed and utilized effectively.

Moreover, an approach to data search that information in all the WWW servers is acquired and preserved in a WWW cache has reached its limit due to the fast growth of the Web. More particularly, the costs required to preserve information in the WWW cache, and communicate or update information have risen, and the search rate has dropped. These problems have derived from dilatation of the Web.

Furthermore, when a database whose data items have neither a structure nor a meaning is searched based on a keyword, an accurate result cannot be obtained. On the other hand, since directory search disables users to sort all Web information by hand, directory search is hard to carry out efficiently.

### SUMMARY OF THE INVENTION

Accordingly, an object of the present invention is to provide a centralizing search system capable of improving compatibility of metadata on the WWW and managing the metadata on the WWW on a centralized manner.

Another object of the present invention is to substantially prevent dilatation of a WWW cache and avoid an increase in the cost of managing the cache.

Still another object of the present invention is to improve precision in search and provide a data structure permitting high-speed search.

Other objects of the present invention will be apparent from the description of embodiments made below.

The precondition of the present invention is that metadata should be described in compliance with the international standard of RDF. This guarantees compatibility and globalization for metadata of various resources.

Furthermore, metadata management in accordance with the present invention is characterized in that metadata scattered into various servers interconnected on the Web is acquired in units of a managing domain that manages metadata, and managed on a logically concentrated manner. The term “managing domain” is adopted based on a concept that resources are divided into groups in terms of URIs that are identifiers assigned to the resources. When it says that metadata is acquired from each managing domain and managed on a centralized manner, it means in practice that domain administration servers are included for acquiring and managing metadata that specifies designated identification information. Each domain administration server includes a metadata management database in which acquired metadata is recorded, and a search engine that searches the metadata management database according to the entered requirements for search.

A method of acquiring metadata that is managed by each domain administration server, that is, a method of updating the metadata management database is based on two typical techniques. According to the first technique, the domain administration server successively accesses servers that manage metadata independently, and queries the servers about presence of metadata that specifies designated identification information. If the metadata specifying designated identification information is located, the domain administration server acquires the metadata and records it in the database. According to the second technique, an RFD agent is distributed to servers. Each server in turn runs the RFD agent to periodically scan metadata stored therein. If metadata relevant to a resource located in a certain managing domain is found, the metadata is transmitted to a domain administration server that administers the managing domain. The combination of these two techniques enables acquisition of data.

Typically, the metadata management database is constructed in order to reply to a request for search issued from a third person. Specifically, when a domain administration server receives a query from a third person over the Web, the domain administration server runs the search engine to judge whether a resource queried about is located in the local domain. If the resource queried about is located in the local domain, the search engine searches the metadata management database so as to execute the query, and returns a reply. A person who utilizes a metadata management database may define a managing domain, whereby the metadata management database may be constructed.

The query to be issued to the search engine is a type of query in which (1) the identifier uniquely assigned to a resource relevant to metadata is specified, (2) either the attribute of the resource or the value the attribute is also specified, whereas (3) the other component is designated as unknown data to be queried about. Be reminded that the three major components of metadata are (1) the identifier uniquely assigned to a resource relevant to metadata, (2) the attribute of the resource, and (3) the attribute value are three elements of metadata. Typically, a query is issued with an identifier and an interesting attribute designated as known data in order to query about unknown data that is an attribute value.

The features of the whole of a metadata management system proposed by the present application will be listed up below.

1. Globalization: since the international standard of URI is used to discriminate one resource from the others, metadata of resources scattered around the world can be managed on the Web.

2. Compatibility: since the international standard of RDF is used to describe metadata, compatibility is guaranteed.

3. Logically-concentrated management: acquired metadata appears centralized.

4. Physically-dispersed preservation: acquired metadata can be preserved while being divided into appropriate portions.

The features of the mechanism of the metadata management system to be disclosed will be listed below.

1. The international standard of URI is used to discriminate one resource, which is described on the Web, from the others (irrespective of whether the resource is physical or logical).

2. Resources are described in compliance with international standard of RDF. According to the present invention, metadata complying with RDF shall be referred to as RDF data. A metadata management system in accordance with the present invention may be referred to as an RDF data management system.

3. A plurality of managing domains is defined in relation to resources bearing different URIs. Each managing domain is regarded as a unit of management in which RDF data is managed. Each unit of management manages only the RDF data of resources located locally.

4. As a method of acquiring RDF data, two techniques are adopted. Namely, the two techniques are a technique that a unit of management or a managing domain collects RDF data of resources, which are located in the managing domain, from general WWW servers, and a technique that each WWW server transmits RDF data saved therein to the unit of management determined as described in item 3. The two techniques are used in combination to acquire RDF data.

5. A query is issued with an identifier URI of a resource (resource division of RDF data) and an interesting attribute of the resource (attribute division of RDF data) designated. An attribute value (value division of RDF data) is returned as a result of querying.

6. Any managing domain can be used to issue the query. A managing domain where a resource is located is judged from a URI assigned to the resource about which a query is issued. If a judged managing domain is different from a managing domain to which the query is issued, the query is transferred to the judged managing domain.

Other and further objects, features and advantages of the invention will appear more fully from the following description.

### BRIEF DESCRIPTION OF THE DRAWINGS

In the attached drawings:

FIG. 1 is a block diagram showing the overall configuration of an RDF data management system in accordance with an embodiment of the present invention;

FIG. 2 is a block diagram showing the concept of a managing domain applied to the embodiment;

FIG. 3 is a block diagram showing the ability of an RDF search engine employed in the embodiment;

FIG. 4 is a block diagram showing the ability of an RDF agent employed in the embodiment;

FIG. 5 is a block diagram showing the ability of the RDF search engine employed in the embodiment;

FIG. 6 is a flowchart describing actions to be performed by an RDF data acquisition module of the RDF search engine;

FIG. 7 is a flowchart describing actions to be performed by an RDF data query processing module of the RDF search engine;

FIG. 8 is a flowchart describing actions to be performed by an RDF database access module of the RDF search engine;

FIG. 9 is a block diagram showing the ability of an RDF agent employed according to the present invention;

FIG. 10 is a flowchart describing actions to be performed by an RDF data search module of the RDF agent;

FIG. 11 is a flowchart describing an RDF data distribution module of the RDF agent;

FIG. 12 is a block diagram showing a practical case where the present invention is implemented;

FIG. 13 shows detailed RDF data created in a practical case where the present invention is implemented;

FIG. 14 shows detailed RDF data created in a practical case where the present invention is implemented;

FIG. 15 shows detailed RDF data created in a practical case where the present invention is implemented;

FIG. 16 shows detailed RDF data created in a practical case where the present invention is implemented; and

FIG. 17 shows a user interface employed in a practical case where the present invention is implemented.

### DESCRIPTION OF THE PREFERRED EMBODIMENTS

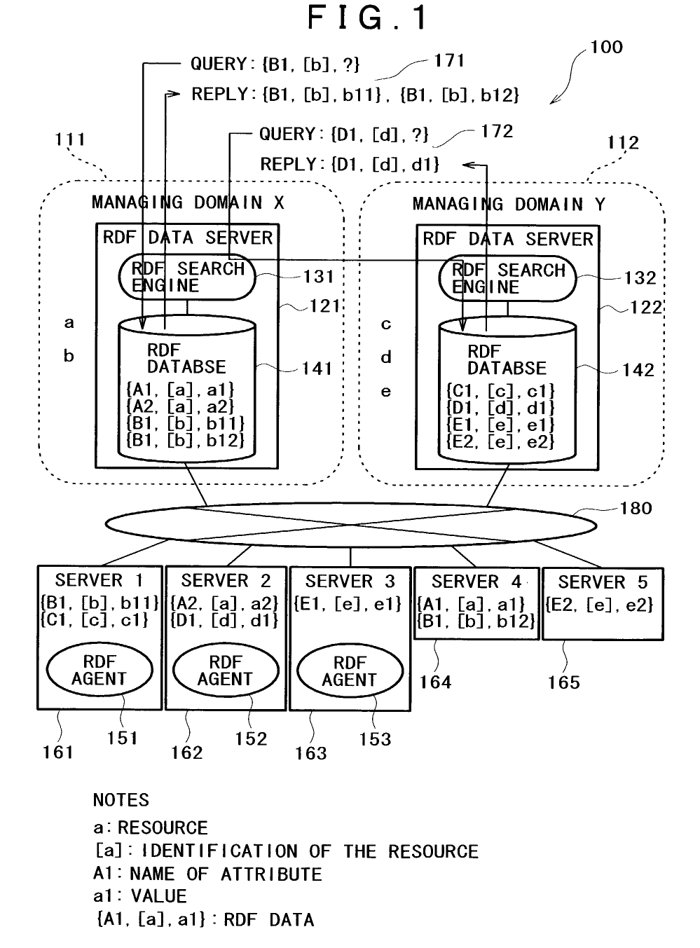

An embodiment of the present invention will be described in conjunction with the drawings below. FIG. 1 shows the configuration of an RDF data management system of an embodiment of the present invention. An RDF data management system 100 consists mainly of managing domains 111 and 112, RDF data servers 121 and 122, and RDF agents 151 to 153. The RDF data server 121 or 122 is composed of an RDF search engine 131 or 132 and an RDF database 141 or 142. Moreover, the RDF agents 151 to 153 are installed in general WWW servers 161 to 163. A query about RDF data 171 or 172 is issued to the RDF data server belonging to any managing domain (for example, managing domain X 111). The servers 121, 122, and 161 to 163 are interconnected over a network 180. In FIG. 1, there are shown two managing domains, two RDF data servers, three RDF agents, and five WWW servers. In practice, the numbers of managing domains, RDF data servers, RDF agents, and WWW servers may be set to any values.

Referring to FIG. 1, there are shown resources a and b. URIs corresponding to the resources are [a] and [b]. Attribute names of the resources are A1, A2, and B1, and attribute values thereof are a1, a2, and b11. RDF data items are described as {A1, [a], a1}, {A2, [a], a2}, and {B1, [b], b11}.

In FIG. 1, managers own the managing domains 111 and 112 so as to manage RDF data of resources that are identified uniquely with the URIs on the WWW.

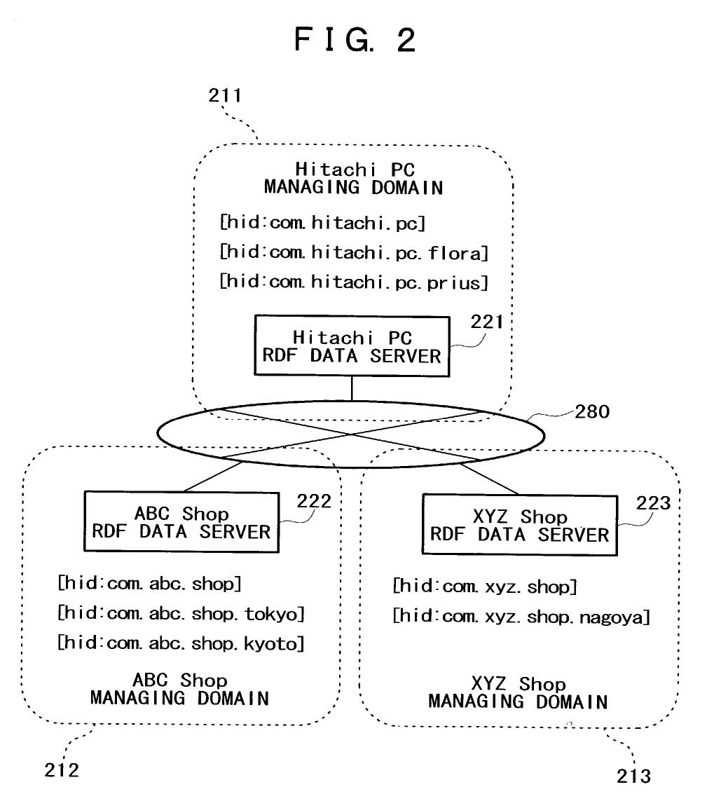

Referring to FIG. 2, the concept of the managing domain will be described more practically. In FIG. 2, resources concerning a Hitachi personal computer, ABC Shop, and XYZ Shop are available on the network 280. These resources are identified with URIs. For example, the resources concerning the Hitachi personal computer bear the URIs of [hid:com.hitachi.pc] and [hid:com.hitachi.pc.flora]. The resources concerning ABC Shop bear the URIs of [hid:com.abc.shop] and [hid:com.abc.shop.tokyo]. For ease of management, a Hitachi personal computer (PC) managing domain 211, an ABC Shop managing domain 212, and an XYZ Shop managing domain 213 are defined, and the resources concerning the Hitachi personal computer, ABC Shop, and XYZ Shop are located in the respective managing domains. The managing domain can be identified based on the URI assigned to the resource located therein. In the example of FIG. 2, three leading parts of the URI assigned to the resource specify the domain where the resource is located. For example, the resources having the URIs [hid:com.hitachi.pc], [hid:com.hitachi.pc.flora], and [hid:com.hitachi.pc.prius] are located in the Hitachi PC managing domain 211. The RDF data servers 221, 222, and 223 belong to the managing domains 211, 212, and 213 respectively. The RDF data servers 221, 222, and 223 acquire and manage RDF data of the resources located in the managing domains 211, 212, and 213 respectively. For example, the Hitachi PC RDF data server 221 manages RDF data whose resource divisions specify [hid:com.hitachi.pc], [hid:com.hitachi.pc.flora], and [hid:com.hitachi.pc.prius].

The RDF data servers 121 and 122 included in the RDF data management system 100 shown in FIG. 1 play the role of managing the attributes of the resources (for example, resources a and b located in the managing domain X 111) located in the managing domains 111 and 112 to which the RDF data servers belong, the attribute values (for example, the attribute A1 of the resource a and the attribute value a1). In short, the RDF data servers 121 and 122 play the role of managing the RDF data of the resources (for example, [A1, [a], a1} and {A2, [a], a2}) in a concentrated manner.

The RDF data servers 121 and 122 are included in the managing domains 111 and 112 shown in FIG. 1 in order to manage the RDF data of the resources located in the managing domains 111 and 112. The RDF data server 121 or 122 is composed of an RDF search engine 131 or 132 and an RDF database 141 or 142.

The RDF search engines 131 and 132 shown in FIG. 1 have the ability to acquire the RDF data of the resources located in the managing domains from the general WWW servers 161 to 165, and record the acquired RDF data in the RDF database 141 or 142.

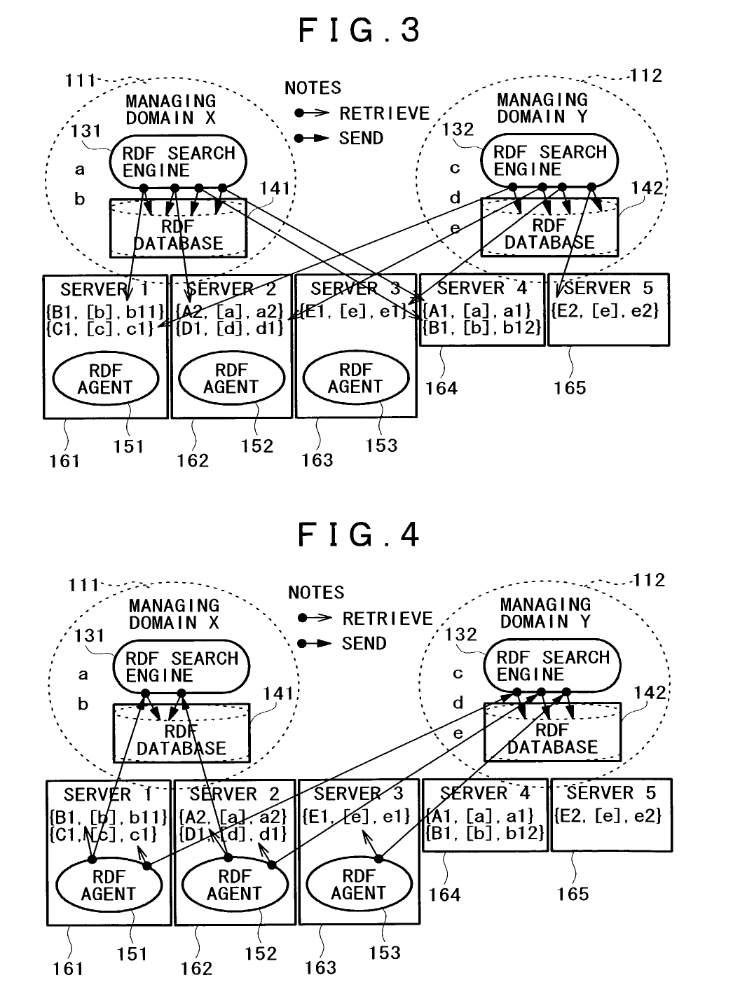

FIG. 3 shows the actions of the RDF search engines 131 and 132 shown in FIG. 1. Referring to FIG. 3, the RDF search engine 131 recognizes that the resources a and b are located in the managing domain X 111, and searches the general WWW servers 161 to 165 for the RDF data of the resources a and b. For example, if the RDF search engine 131 finds the RDF data {B1, [b], b11} of the resource b in server 1 161, the RDF data is transferred and recorded in the RDF database 141. Likewise, the RDF search engine 132 recognizes that the resources c, d, and e are located in managing domain Y 112, and searches the general WWW servers 161 to 165 for the RDF data of the resources c, d, and e. For example, if the RDF data {C1, [c], c1} of the resource c is found in the server 1 161, the RDF data is transferred and recorded in the RDF database 142.

The RDF data of the resources located in the managing domains 111 and 112 are recorded in advance in the RDF databases 141 and 142 shown in FIG. 1. For example, as shown in FIG. 1, the RDF data {A1, [a], a1}, {A2, [a], a2}, {B1, [b], b11}, and {B1, [b], b12} of the resources a and b is recorded in the RDF database 141 belonging to the managing domain 111. When the present invention is implemented, there are no limitations on the kind of database to be adopted as the RDF database. An implementing person can select an appropriate database management system (for example, HiRDB released from Hitachi Ltd.) so as to manage RDF data.

The RDF agents 151 to 153 shown in FIG. 1 are installed in the general WWW servers 161 to 163 respectively. The RDF agents 151 to 153 search for RDF data saved in the servers 161 to 163, and transfer found RDF data to an appropriate RDF search engine. Herein, the appropriate RDF search engine is an RDF search engine residing in a managing domain where a resource relevant to the RDF data is located.

FIG. 4 shows the actions of the RDF agents 151 to 153 shown in FIG. 1. For example, in FIG. 4, assume that the RDF agent 151 finds RDF data {B1, [b], b11}. In this case, since the resource b relevant to the RDF data is located in the managing domain X 111, the RDF agent 151 transfers the RDF data to the RDF search engine 131 residing in the managing domain X 111. The RDF search engine 131 transfers and records the RDF data in the RDF database 141. Likewise, if the RDF agent 151 finds RDF data {C1, [c], c1}, since the resource c relevant to the RDF data is located in managing domain Y 112, the RDF agent 151 transfers the RDF data to the RDF search engine 132 residing in the managing domain Y 112. The RDF search engine 132 in turns transfers and records the RDF data in the RDF database 142.

Generally, the queries 171 and 172 about RDF data shown in FIG. 1 each specify the resource and attribute divisions of RDF data and query about the value division thereof. When the queries 171 and 172 are issued to the RDF data server 121 belonging to the managing domain X 111, the RDF search engine 131 receives the queries 171 and 172. The RDF search engine 131 judges whether the resource about which each query is issued is located in the managing domain X 111, and determines whether it should access the local RDF database 141 or transfer the query to another managing domain. In the example shown in FIG. 1, the resource b about which the query 171 {B1, [b], ?} is issued is located in the managing domain X 111, the RDF search engine 131 accesses the local RDF database 141 and prepares a reply. In contrast, the resource d about which the query 172 {D1, [d], ?} is issued is not located in the managing domain X 111 but located in the managing domain Y 111. The RDF search engine 131 therefore transfers the query 172 to the RDF data server 122 belonging to the managing domain Y 112. The RDF data server 122 acts similarly to the RDF data server 121 so as to treat the query 172.

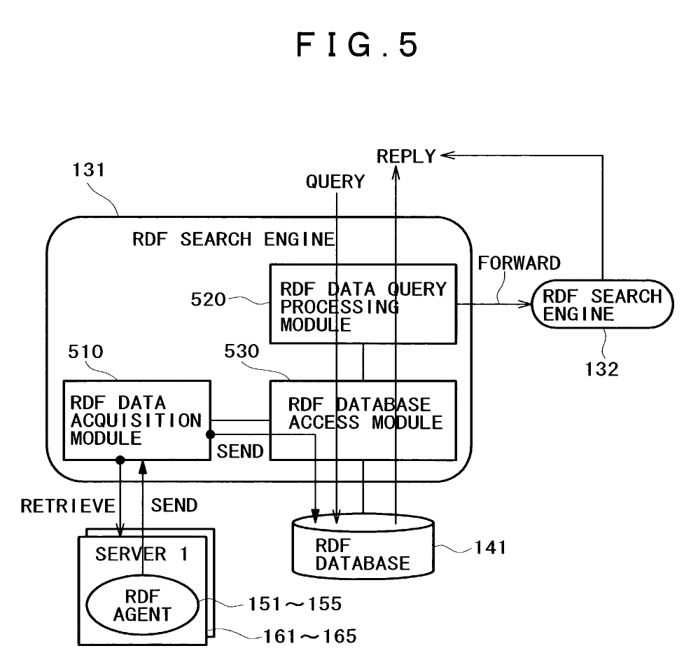

FIG. 5 shows the configuration of the RDF search engine 131. The RDF search engine 131 consists mainly of an RDF data acquisition module 510, an RDF data query processing module 520, and an RDF database access module 530.

The RDF data acquisition module 510 adopts two techniques in combination to acquire RDF data. According to one of the techniques, the general WWW servers 161 to 165 are accessed in order to search for RDF data. According to the other technique, the RDF agents 151 to 153 residing in the general WWW servers 161 to 163 are requested to search for RDF data.

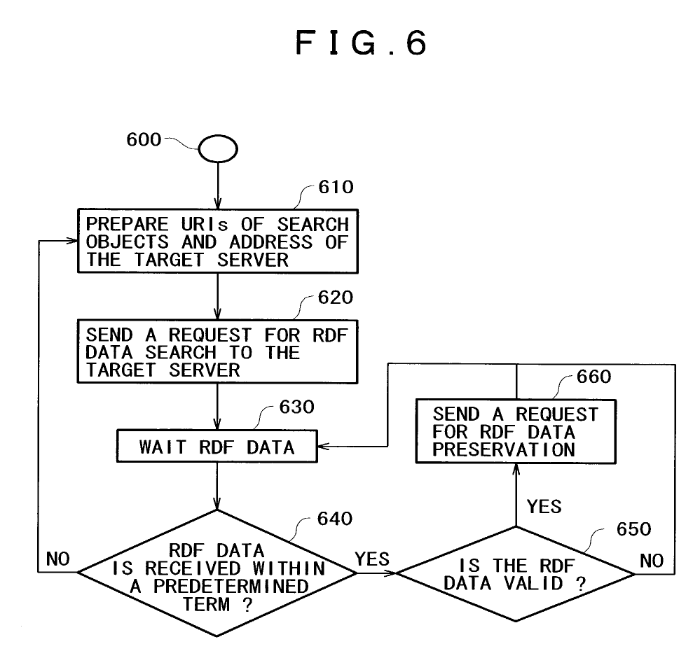

FIG. 6 is a flowchart describing a sequence of actions to be performed by the RDF data acquisition module 510. Once the RDF data acquisition module 510 that is a program is started (step 600), the RDF data acquisition module 510 runs infinitely repeatedly. First, a URI of a resource whose RDF data is searched for and the address of a server to be searched are acquired (step 610). The URI of the resource whose RDF data is searched for is used to issue a request to search for RDF data, which is an object of search, to the server to be searched (step 620). Thereafter, RDF data is awaited (step 630). RDF data to be awaited includes not only RDF data that satisfies the search request issued from the RDF data acquisition module 510 but also RDF data any of the RDF agents 151 to 153 has found and transferred. It is then judged whether RDF data is received within a certain period of time (step 640). If RDF data is received (the judgment is made in the affirmative at step 640), it is judged whether the received RDF data is valid (step 650). If RDF data is not received (the judgment is made in the negative at step 640), control is returned to the first step 610. A URI of a resource whose RDF data is searched for next and the address of a server to be searched are acquired. If received RDF data is RDF data of a resource located in a managing domain and complies with the RDF standard, the RDF data is valid. If the RDF data is valid, a request to preserve the RDF data is issued to the RDF database access module 530 (step 660). Control is then returned to step 630 and RDF data is awaited. If the RDF data is invalid, the RDF data is discarded. Control is then returned to step 630, and the next RDF data is awaited.

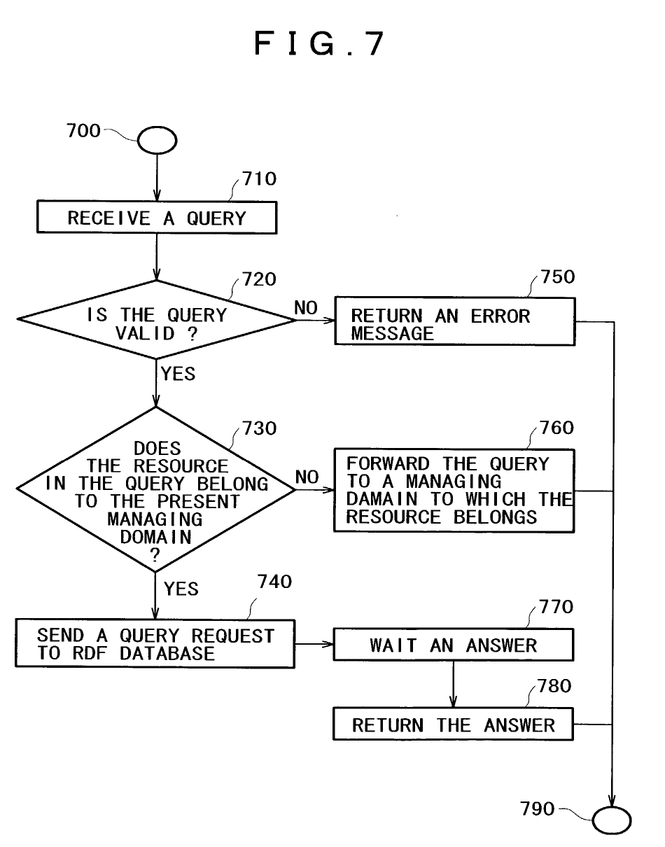

The RDF data query processing module 520 checks the validity of a query about RDF data and judges to what managing domain a query should be transferred. FIG. 7 is a flowchart describing a sequence of actions to be performed by the RDF data query processing module 520. The RDF data query processing module 520 that is a program is called (step 700). First, the RDF data query processing module 520 receives a query about RDF data (step 710), and checks if the query is valid (step 720). If the query complies with the RDF standard and specifies the resource and attribute divisions of RDF data concerned, the query is valid. If the query is valid, control is passed to step 730. If the query is invalid, an error interrupt is returned (step 750). The program then terminates (step 790). Thereafter, the resource division (URI of a resource) specified in the query is checked to see if the resource relevant to the RDF data is located in the local managing domain (step 730). If the resource is located in the managing domain (if the judgment is made in the affirmative at step 730), access is gained to the RDF database belonging to the local managing domain. The query that is a request to query about RDF data is transferred to the RDF database access module 530 (step 740), and a reply is awaited (step 770). If a reply is received, the reply is returned (step 780). The program then terminates (step 790). If the resource is not located in the local managing domain (the judgment is made in the negative at step 730), the query is transferred to a managing domain where the resource is located (step 760). The program then terminates (step 790).

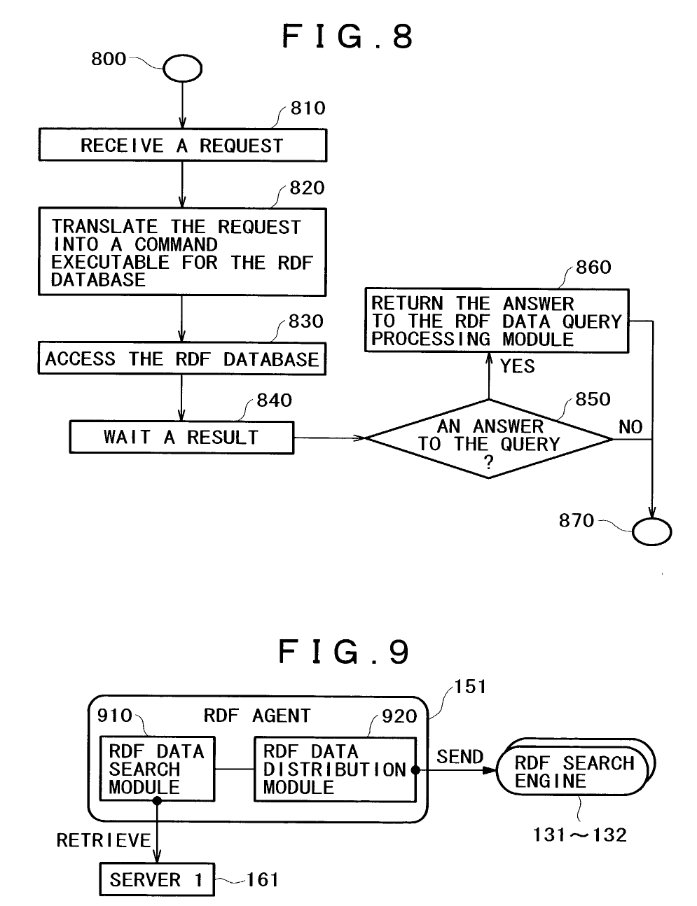

The RDF database access module 530 actually accesses an RDF database in response to a request to access an RDF database issued from the RDF data acquisition module or RDF data query processing module. FIG. 8 is a flowchart describing a sequence of actions to be performed by the RDF database access module 530. When called (step 800), the RDF database access module 530 that is a program first receives a request to preserve RDF data from the RDF data acquisition module or receives a request to query about RDF data from the RDF data query processing module (step 810). The RDF database access module 530 then converts the request into a command executable relative to an RDF database (step 820). The command is used to access the RDF database (step 830), and the result of access is then awaited (step 840). When the result of access is received, it is judged whether the result of access is a reply to the query about RDF data (step 850). If the judgment is made in the affirmative, the reply is returned to the RDF data query processing module 520 (step 860). The program then terminates (step 870). If the judgment is made in the negative, the program terminates (step 870).

FIG. 9 shows the configuration of the RDF agent 151. The RDF agent 151 consists mainly of an RDF data search module 910 and an RDF data distribution module 920.

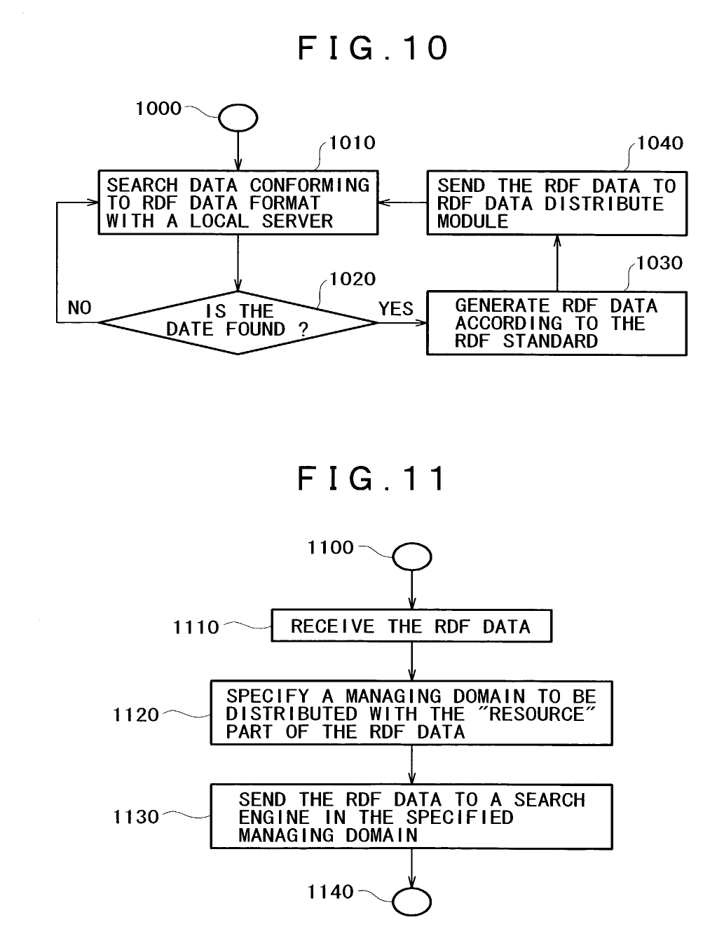

The RDF data search module 910 searches a server, in which the RDF data search module 910 resides, for RDF data. FIG. 10 is a flowchart describing a sequence of actions to be performed by the RDF data search module 910. Once started (step 1000), the RDF data search module 910 that is a program runs repeatedly. First, the RDF data search module 910 searches a server, in which the RDF data search module resides, for example, server 1 161 for data serving as RDF data (steps 1010 and 1020). If found data is not formatted as RDF data, RDF data is created in compliance with the RDF standard (step 1030). Thereafter, the RDF data is transferred to the RDF data distribution module (step 1040). Finally, control is returned to the first step 1010, and the next RDF data is searched for.

The RDF data distribution module 920 distributes RDF data received from the RDF data search module 910 to an RDF search engine residing in a domain that manages the RDF data. FIG. 11 is a flowchart describing a sequence of actions to be performed by the RDF data distribution module 920. When called (step 1100), the RDF data distribution module 920 that is a program first receives RDF data (step 1110). It is then judged from the resource division of the RDF data to what managing domain the RDF data should be distributed (step 1120). Thereafter, the RDF data is transferred to an RDF search engine residing in the judged managing domain. Finally, the program terminates (step 1140).

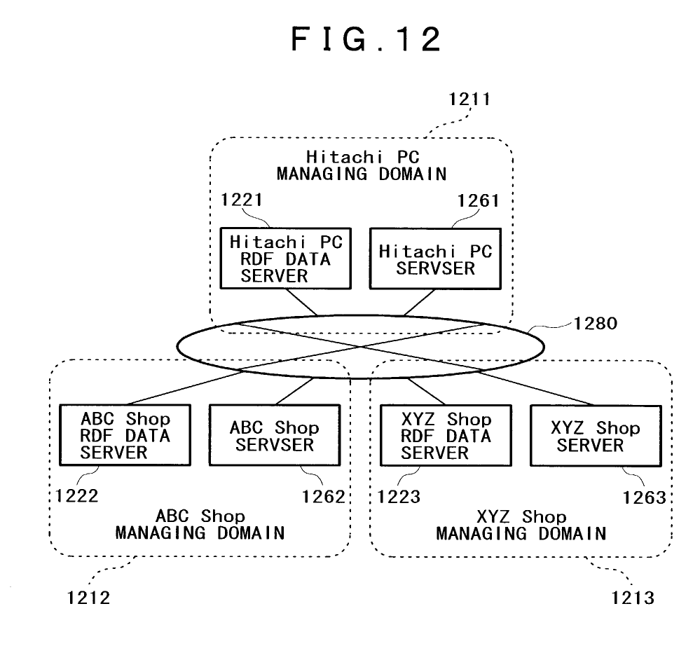

FIG. 12 to FIG. 16 shows information linkage attained between a personal computer vendor and its retailer owing to the RDF data management system in accordance with the present invention, and practical cases. In a case shown in FIG. 12, the personal computer vendor is Hitachi Ltd. and the retailer is ABC Shop and XYZ Shop. The Hitachi personal computer vendor, and the ABC Shop and XYZ Shop belong to a Hitachi PC managing domain 1211, an ABC Shop managing domain 1212, and an XYZ Shop managing domain 1213 respectively. Consequently, a Hitachi PC server 1261, an ABC Shop server 1262, and an XYZ Shop server 1263 that are general WWW servers belong to the three managing domains. Moreover, a Hitachi PC RDF data server 1221, an ABC Shop RDF data server 1222, and an XYZ Shop RDF data server 1223 that are RDF data servers belong to the three managing domains. These servers are interconnected over a network 1280.

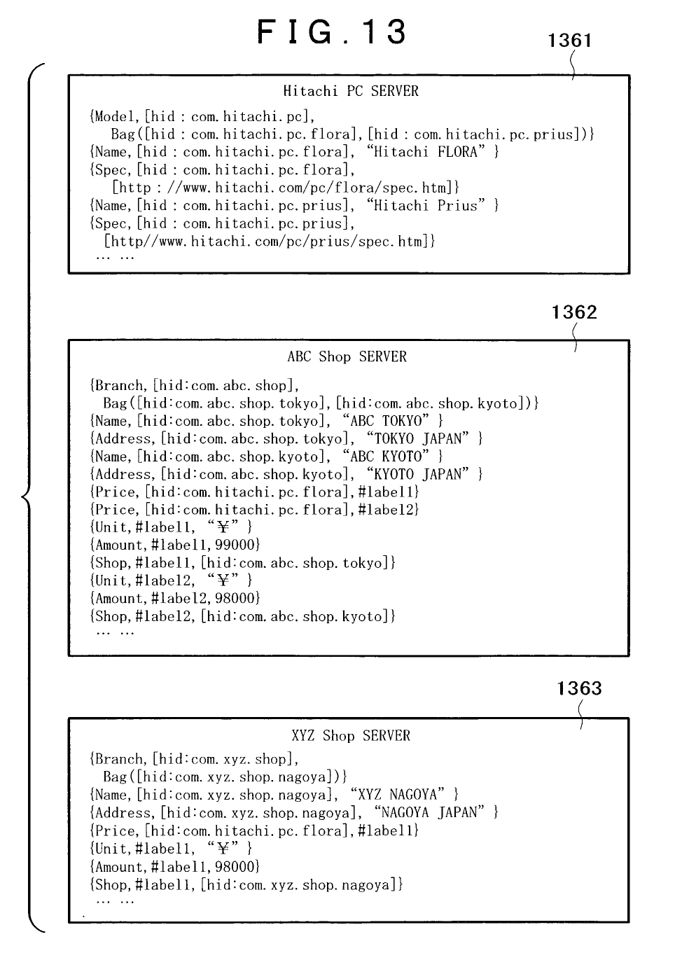

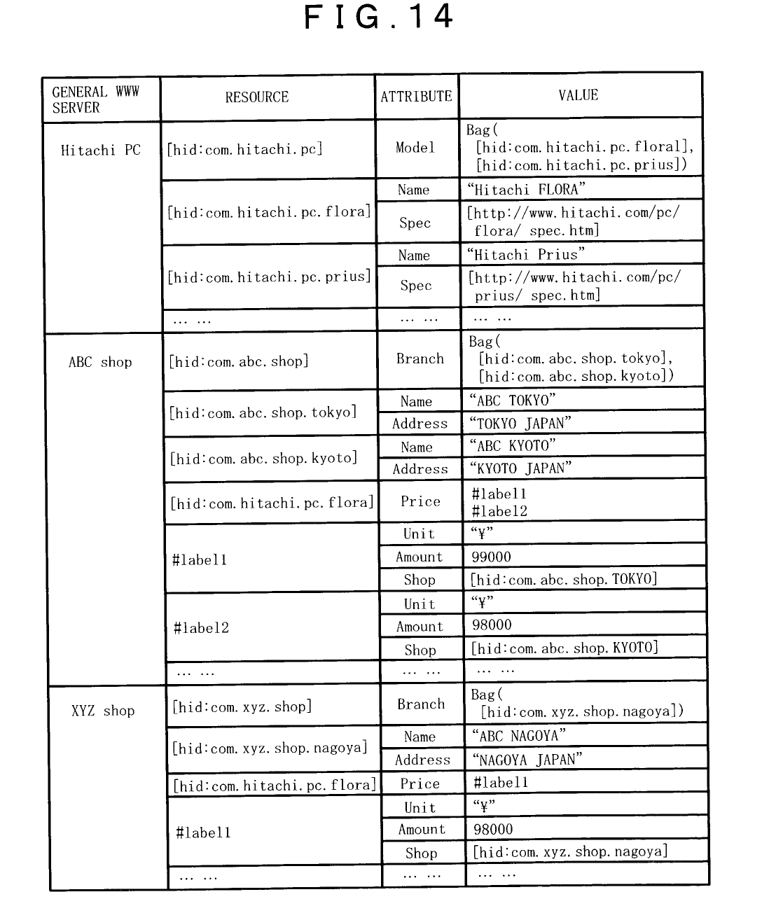

FIG. 13 shows RDF data 1361 held in the Hitachi PC server 1261, RDF data 1362 held in the ABC Shop server 1262, and RDF data 1363 held in the XYZ Shop server 1263 respectively, and FIG. 14 shows the RDF data in the form of a table. The RDF data is information relevant to each company. For example, the Hitachi PC server 1261 holds the RDF data that represents models of Hitachi personal computers, names thereof, and specifications therefor. The ABC Shop server 1262 holds the RDF data that represents offices of ABC Shop, names and addresses of the offices, and prices of products.

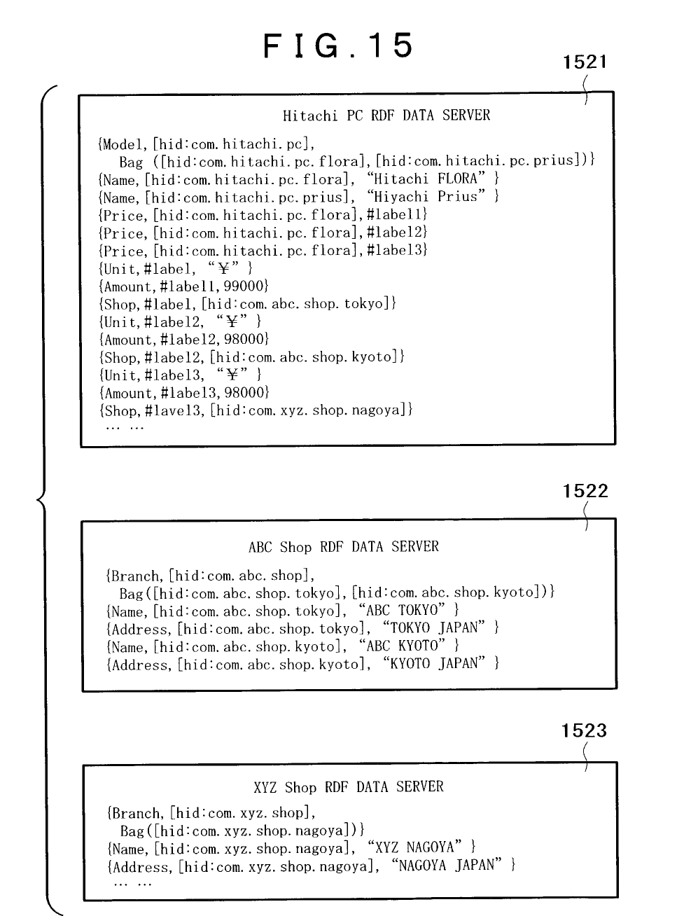

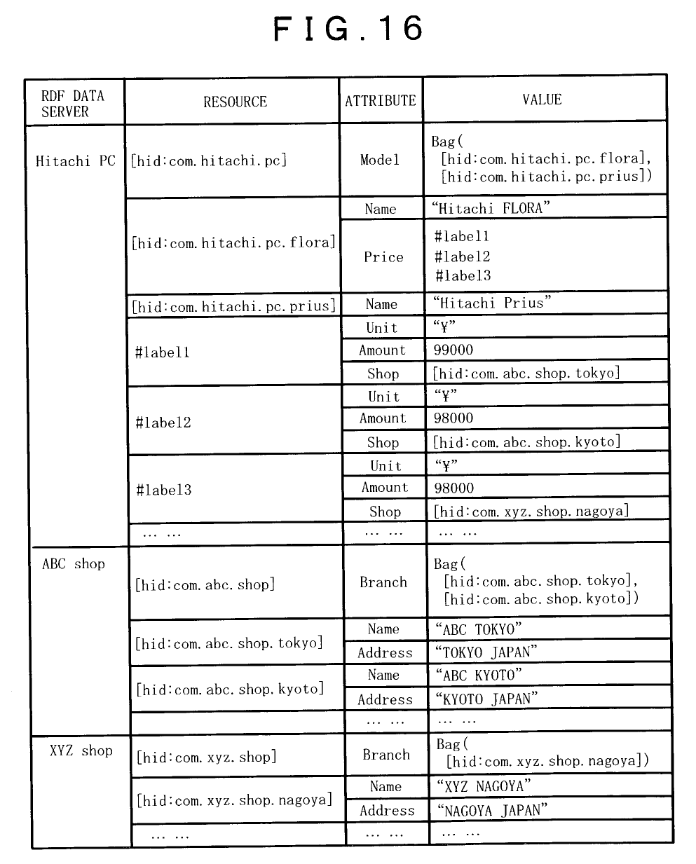

The Hitachi PC RDF data server 1221 acquires information directly related to Hitachi personal computers (for example, models, names, and prices) from the general WWW servers 1261 to 1263, and manages it. The ABC Shop RDF data server 1222 acquires information directly related to ABC Shop (for example, offices, and names and addresses of the offices) from the general WWW servers 1261 to 1263, and manages it. The XYZ Shop RDF data server 1223 acquires information directly related to XYZ Shop (for example, offices, and names and addresses of the offices) from the general WWW servers 1261 to 1263, and manages it. FIG. 15 shows the RDF data items 1521 to 1523 acquired by the three RDF data servers 1221 to 1223, and FIG. 16 shows them in the form of a table.

Queries and replies that will be described below may be made relative to the RDF data shown in FIG. 15 and FIG. 16. In examples shown below, a question mark ? denotes unknown information (that is, information that should be searched for), and => denotes a reply to a query.

Query 1: made about models of Hitachi personal computers.

Step 1: {Model, [hid:com.hitachi.pc], ?}=&gt; {Model, [hid:com.hitachi.pc], Bag([hid:com.hitachi.pc.flora], [hid:com.hitachi.pc.prius])}

Step 2 {Name, [hid:com.hitachi.pc.flora], ?}=&gt; {Name, [hid:com. hitachi. pc. flora], “Hitachi FLORA”}

Step 3: {Name, [hid:com. hitachi. pc. prius], ?}=%gt; {Name, [hid: com. hitachi. pc. prius], “Hitachi Prius”}

Reply 1: made as Hitachi Flora and Hitachi Prius.

Query 2: made about the lowest price of Hitachi Flora, an office where the Hitachi Flora of the lowest price is sold, and the address of the office.

Step 1: {Price, [hid: com. hitachi. pc. flora], ?}=&gt; {Price, [hid: com. hitachi. pc. flora], #label1}{Price, [hid: com. hitachi. pc. flora], #label2}{Price, [hid: com. hitachi. pc. flora], #label3}

Step 2: {Unit, #label1, ?}=&gt; {Unit, #label 1, “Y”}

Step 3: {Amount, #label1, ?}=&gt; {Amount, #label1, 99000}

Step 4: {Unit, #label2, ?}=&gt; {Unit, #label2, “Y”}

Step 5: {Amount, #label2, ?}=&gt; {Amount, #label2, 98000}

Step 6: {Unit, #label3, ?}=&gt; {Unit, #label3, “Y”}

Step 7: {Amount, #label3, ?}=&gt; {Amount, #label2, 98000}

Step 8: {Shop, #label2, ?}=&gt; {Shop, #label2, [hid: com. abc. shop. kyoto]}

Step 9: {Shop, #label3, ?}=&gt; {Shop, #label3, [hid: com. xyz. shop. nagoya]}

Step 10: {Name, [hid: com. abc. shop. kyoto], ?}=&gt; {Name, [hid: com. abc. shop. kyoto], “ABC Kyoto”}

Step 11: {Address, [hid: com. abc. shop. kyoto], ?}=&gt; {Address, [hid: com. abc. shop. kyoto], “Kyoto-shi in Japan”}

Step 12: {Name, [hid: com. abc. shop. nagoya], ?}=&gt; {Name, [hid: com. abc. shop. nagoya], “XYZ Nagoya”}

Step 13: {Address, [hid: com. abc. shop. nagoya], ?}=&gt; {Address, [hid: com.abc. shop. nagoya], “Nagoya-shi in Japan”}

Reply 2: made as the price is 9,800 yen, the offices are ABC Kyoto and XYZ Nagoya, and the addresses of the offices are Kyoto-shi in Japan and Nagoya-shi in Japan.

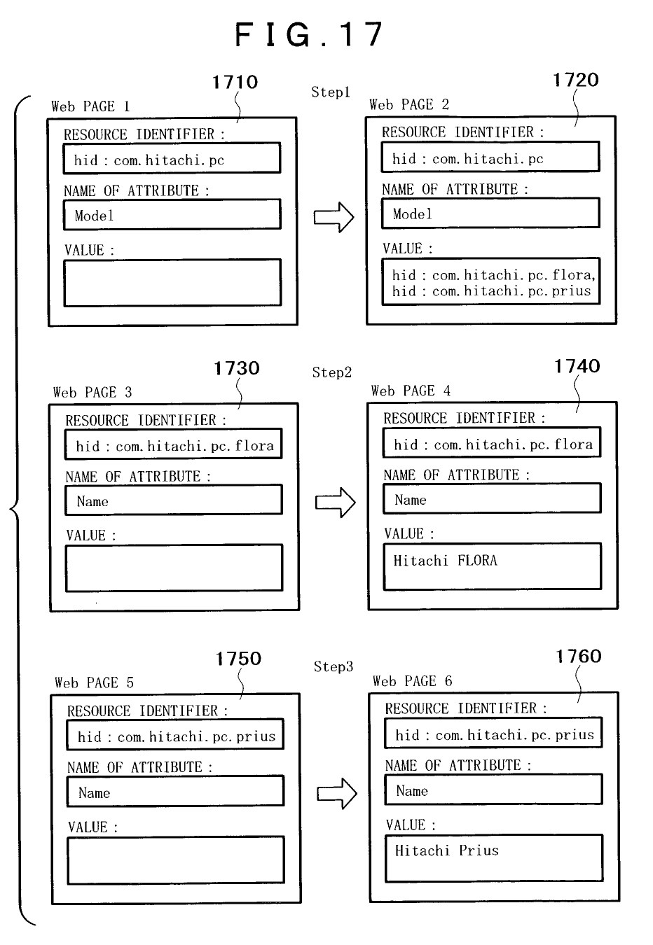

FIG. 17 shows a user interface to be used to make the foregoing queries. Web pages 1 to 6 1710 to 1760 are opened in order to perform steps 1 to 3 out of steps required to make the above query 1. An identifier of a resource and a name of an attribute are entered in respective fields “Resource identifier” and “Attribute name.” An output of resultant values is presented in a field “Value.” For example, at step 1, hid:com.hitachi.pc and Model are entered in “Resource identifier” and “Attribute name” respectively. Consequently, hid:com.hitachi.pc.flora and hid:com.hitachi.pc.prius are returned and presented in the field “Value.”

XML files containing the data shown in FIG. 15 and FIG. 16 and being actually recorded in the RDF database in each RDF data server are described as follows:

RDF database in the Hitachi PC RDF data server (described in XML):

&lt; rdf: RDF

xmlns:rdf=“http://www.w3.org/1999/02/22-rdf-syntax-ns#”

xmlns:prod=“http://product.org/schema/”&gt;

&lt;rdf:Description about=“hid:com.hitachi.pc”&gt;

&lt;prod:Model&gt;

&lt;rdf:Bag&gt;

&lt;rdf:li resource=“hid:com.hitachi.pc.flora”/&gt;

&lt;rdf:li resource=“hid;com.hitachi.pc.prius”/&gt;

&lt;/rdf:Bag&gt;

&lt;/prod:Model&gt;

&lt;/rdf:Descrition&gt;

&lt;rdf:Description about=“hid:com.hitachi.pc.flora”&gt;

&lt;prod:Name&gt;Hitachi FLORA&lt;/prod:Name&gt;

&lt;prod:Price&gt;

&lt;rdf:Bag&gt;

&lt;rdf:li resource=“#label1”/&gt;

&lt;rdf:li resource=“#label2”/&gt;

&lt;rdf:li resource=“#label3”/&gt;

&lt;/rdf:Bag&gt;

&lt;/prod:Price&gt;

&lt;/rdf:Description&gt;

&lt;rdf:Description about=“hid:com.hitachi.pc.prius”&gt;

&lt;prod:Name&gt; Hitachi Prius&lt;/prod:Name&gt;

&lt;/rdf:Description

&lt;rdf:Description ID=“label1”&gt;

&lt;prod:Unit&gt;¥&lt;/prod:Unit&gt;

&lt;prod:Amount&gt99000&lt;/prod:Amount

&lt;prod:Shop resource=“hid:com.abc.shop.Tokyo”/&gt;

&lt;/rdf:Description&gt;

&lt;rdf:Description ID=“label2”&gt;

&lt;prod:Unit&gt;¥&lt;/prod:Unit&gt;

&lt;prod:Amount&gt;98000&lt;/prod:Amount&gt;

&lt;prod:Shop resource=“hid:com.abc.shop.Kyoto”/&gt;

&lt;/rdf:Description&gt;

&lt;rdf:Description ID=“label3”&gt;

&lt; prod:Unit&gt;¥&lt;/prod:Unit&gt;

&lt;prod:Amount&gt;98000&lt;/prod:Amount&gt;

&lt;prod:Shop resource=“hid:com.xyz.shop.Nagoya”/&gt;

&lt;/rdf:RDF&gt;

RDF database in the ABC Shop RDF data server (described in XML)

&lt;rdf:RDF

xmlns:rdf=“http://www.w3.org/1999/02/22-rdf-syntax-ns#”

xmlns:shop=“http://shop.org/schema/”&gt;

&lt;rdf:Description about=“hid:com.abc.shop”&gt;

&lt;shop:Branch&gt;

&lt;rdf:Bag&gt;

&lt;rdf:li resource=“hid:com.abc.shop.Tokyo”/&gt;

&lt;rdf:li resource=“hid:com.abc.shop.Kyoto”/&gt;

&lt;/rdf:Bag&gt;

&lt;/shop:Branch&gt;

&lt;/rdf:Description&gt;

&lt;rdf:Description about=“hid:com.abc.shop.Tokyo”&gt;

&lt;shop:Name&gt;ABC Tokyo&lt;/shop:Name&gt;

&lt;shop:Address&gt;Tokyo in Japan &lt;/shop: Address&gt;

&lt;/rdf:Description&gt;

&lt;rdf:description about=“hid:com.abc.shop.Kyoto”&gt;

&lt;shop:Name&gt;ABC Kyoto&lt;/shop:Name&gt;

&lt;shop:address&gt;Kyoto-shi in Japan

&lt;/shop:Address&gt;

&lt;/rdf:Description&gt;

&lt;/rdf:RDF&gt;

RDF database in the XYZ Shop RDF data server (described in XML)

&lt;rdf:RDF

xmlns:rdf=“http://www.w3.org/1999/02/22-rdf-syntax-ns#”

xmlns:shop=“http://shop.org/schema/”&gt;

&lt;rdf:Description about=“hid:com.xyz.shop”&gt;

&lt;shop:Branch&gt;

&lt;rdf:Bag&gt;

&lt;rdf:li resource=“hid:com.xyz.shop.Nagoya”/&gt;

&lt;/rdf:Bag&gt;

&lt;/shop:Branch&gt;

&lt;/rdf:Description&gt;

&lt;rdf:Description about=“hid:com.xyz.shop.Nagoya”&gt;

&lt;shop:Name&gt;XYZ Nagoya&lt;/shop:Name&gt;

&lt;shop:Address&gt;Nagoya-shi in Japan

&lt;/shop:Address&gt;

&lt;/rdf:Description&gt;

&lt;/rdf:RDF&gt;

Using the RDF data management system in accordance with the present invention, all metadata on the WWW can be managed on a centralized manner with the compatibility thereof guaranteed.

Furthermore, since RDF data is dispersedly preserved on behalf of Web pages, dilatation of the WWW cache can be prevented.

Furthermore, a data structure and a meaning can be expressed, and a query is made on the level of RDF data managed in a concentrated manner. Therefore, search can be achieved highly precisely at a high speed.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A metadata management system employed in an environment in which metadata of various resources is dispersedly saved in a plurality of metadata servers interconnected over a computer network, comprising:
a plurality of domain administration servers, interconnected over said computer network, for acquiring metadata, which specifies identification information assigned to a resource located in an associated domain, from said metadata servers interconnected over said computer network, and preserving acquired metadata, wherein:
each domain administration server includes a metadata management database in which acquired metadata is recorded, and a search engine that searches said metadata management database for metadata that meets the requirement for search provided as the identification information.

2. A metadata management system according to claim 1, wherein said metadata specifies three information items; that is, an identifier that is uniquely assigned to a resource relevant to the metadata, an attribute of the resource, and a value the attribute assumes.

3. A metadata management method, employed in an environment in which a plurality of metadata servers in which metadata of various resources is dispersedly saved is interconnected over a computer network, for acquiring metadata, which specifies identification information assigned to a resource located in an associated domain, and preserving the metadata in a domain administration server connected on said computer network, said metadata management method comprising the steps:
allowing said domain administration server to successively access said plurality of metadata servers and successively fetch metadata from said metadata servers;
comparing the fetched metadata with the identification information;
when the identification information is specified in said fetched metadata, saving said metadata in a metadata management database included in said domain administration server.

4. A metadata management method, implemented in a metadata management system in which a plurality of metadata servers in which metadata of various resources is dispersedly saved and a plurality of domain administration servers each preserving metadata that specifies identification information assigned to a resource located in an associated domain are interconnected over a computer network, for preserving metadata, which specifies the assigned identification information, in each domain administration server, said metadata management method comprising the steps of:
allowing each metadata server to scan metadata saved therein;
comparing identification information assigned to a resource located in a domain associated with each domain administration server with the identification information specified in the scanned metadata so as to find a domain administration server associated with the domain in which the resource relevant to the metadata is located; and
transmitting the metadata to the domain administration server associated with the domain in which the resource relevant to the metadata is located, wherein:
said plurality of domain administration servers each receive metadata, and metadata specifying assigned identification information can thus be acquired.

5. A metadata search method using a search engine, implemented in a metadata management system in which a plurality of metadata servers interconnected over a computer network dispersedly holds metadata that specifies three information items, that is, an identifier assigned uniquely to a resource, an attribute of the resource, and a value the attribute assumes, in which a plurality of domain administration servers acquires metadata, which specifies the assigned identification information, from said metadata servers and preserves it, and in which each domain administration server includes a metadata management database in which acquired metadata is recorded, and a search engine that searches said metadata management database for metadata that meets the requirement for search provided as the identification information, said metadata search method comprising the steps of:
receiving a request for search that specifies as known data two of three data items, that is, an identifier uniquely assigned to a resource relevant to metadata and one of an attribute of the resource and a value the attribute assumes, and that requests unknown data that is the other of the attribute of the resource and the value the attribute assumes;
searching said metadata management database using the known data specified in the search request; and
retrieving metadata, which specifies the known data, from said metadata management database.

6. A metadata searching method according to claim 5, further comprising the steps of:
judging whether the identifier specified in the received search request agrees with the identification information assigned to the resource relevant to the object of acquisition performed by said domain administration server; if it is judged that the identifier disagrees with the identification information, finding another domain administration server associated with a domain in which the resource to which the identifier is assigned is located; and transferring the requirements for search specified in the search request to a search engine residing in the found domain administration server;
allowing said search engine residing in the found domain administration server to search said metadata management database included in the local domain administration server according to the transferred requirements for search specified in the search request; and
allowing said search engine residing in the found domain administration server to return the result of search to a search engine that has issued the search request.

7. A metadata search method according to claim 5, further comprising the steps of:
displaying a prompt on the screen of a user's computer connected on said network so as to prompt a user to enter information items of (1) an identifier of a resource, (2) an attribute name, and (3) an attribute value so that the requirements for search specified in the search request will be transmitted to said search engine;
checking if the user has entered the resource identifier out of the three information items and also entered either the attribute name or attribute value;
executing search using the entered information, and displaying the result of search on the screen of said user's computer.

8. A metadata management method employed in an environment in which a plurality of metadata servers in which metadata of various resources is dispersedly saved is interconnected over a communication network, said metadata management method comprising the steps of:
acquiring metadata, which specifies identification information assigned by a requester, from said plurality of metadata servers;
preserving acquired metadata in a metadata management database; and
permitting the requester to utilize said metadata management database.
